(19) United States
(12) Patent Application Publication
(10) Pub. No.: US 2018/0101856 A1
(43) Pub. Date: Apr. 12, 2018

(54) DIGITAL PROCESSING SYSTEM AND DEVICE TO COMMUNICATE AND TRACK A TEMPLATE-BASED CUSTOMIZED DIGITAL OBJECT THROUGH SOCIAL MEDIA

(71) Applicant: Photopon, Inc., Hackettstown, NJ (US)

(72) Inventors: Bradford Alexander McEvilly, Newton, NJ (US); Michael Scott Gutkin, Denville, NJ (US)

(21) Appl. No.: 15/838,216

(22) Filed: Dec. 11, 2017

Related U.S. Application Data
(63) Continuation of application No. 14/514,992, filed on Oct. 15, 2014, now abandoned.
(60) Provisional application No. 61/891,370, filed on Oct. 15, 2013.

(51) Int. Cl. G06Q 30/02; H04W 4/02

(52) U.S. Cl. CPC G06Q 30/0224; H04W 4/025

(57) ABSTRACT

A digital processing system to communicate and track a template-based customized digital object including a mobile user terminal and a server. The terminal includes an RF interface to receive position location signals, a processor to determine a geographic location of the terminal from the position location signals, a second RF interface to exchange signals with a WAN, and user-interface means to display and to edit a digital object template. The server includes a WAN interface to receive a first signal indicating the geographic location of the mobile user terminal, and a second signal representing a media data object from the terminal, a template database to store the digital object template displayed on the user-interface means, a processor combining the digital object template with the media data object according to user commands, and a presentation module to present the customized digital object to a recipient user at another mobile user terminal.

### CROSS-REFERENCE TO RELATED APPLICATIONS

This application is a continuation of U.S. application Ser. No. 14/514,992, filed Oct. 15, 2014, which in turn claims the benefit of U.S. Provisional Application Ser. No. 61/891,370, filed Oct. 15, 2013, both of which are incorporated herein by reference in their entirety.

### BACKGROUND

### Field of the Invention

Automatic coupon code generation per user per existing coupon template, using location information.

### SUMMARY

Embodiments in accordance with the present disclosure may provide a system, apparatus and/or method to provide automatic coupon code generation that is individualized to a user and is individualized to a predetermined coupon template.

A “Photopon location-based coupon” as used herein may refer to a location-based sharable benefit such as a discount, rebate, loyalty points, free item, etc., which may be enabled by a business (e.g., a business such as a restaurant or tavern, etc.), and which may be selected by a requesting user (e.g., a user or a customer of the business), who may also be referred to herein as a requesting user, and delivered to a recipient user (e.g., a person within a social circle of the requesting user). The locations of the business and the requesting user, either absolutely or relative to each other, may determine a selection of available location-based coupons. The location of the recipient user (either absolutely or relative to the business or the requesting user) may determine whether a location-based coupon may be delivered to the recipient user.

### BRIEF DESCRIPTION OF THE DRAWINGS

The above examples and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a system in accordance with an embodiment of the present invention;

FIG. 2 illustrates an architecture for an external communication device;

FIG. 3 is a flow chart depicting a method at a user terminal in accordance with an embodiment of the present invention;

FIG. 4 is a flow chart depicting a method at a server in accordance with an embodiment of the present invention; and

FIG. 5 is a flow chart depicting a method of providing a benefit in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

The disclosure will be illustrated below in conjunction with an exemplary social network communication system. Although well suited for use with, e.g., a system using a server(s) and/or database(s), the disclosure is not limited to use with any particular type of communication system, network, or configuration of system elements. Those skilled in the art will recognize the disclosed techniques may be used in any communication application in which it is desirable to utilize applications in a peer-to-peer network, or Internet network.

The exemplary systems and methods of this disclosure will also be described in relation to software, modules, and associated computing hardware. However, to avoid unnecessarily obscuring the present disclosure, the following description omits well-known structures, components and devices that may be shown in block diagram form, are well known, or are otherwise summarized.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting an electrical signal.

The term “computer-readable medium” as used herein refers to any tangible storage and/or transmission medium that participate in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read.

A media data object file attachment to e-mail or other self-contained information archive or set of archives is considered a distribution medium equivalent to a tangible storage medium. When the computer-readable media is configured as a database, it is to be understood the database may be any type of database, such as hierarchical, object-oriented, and/or the like. Accordingly, the disclosure is considered to include a tangible storage medium or distribution medium and prior art-recognized equivalents and successor media, in which the software implementations of the present disclosure are stored.

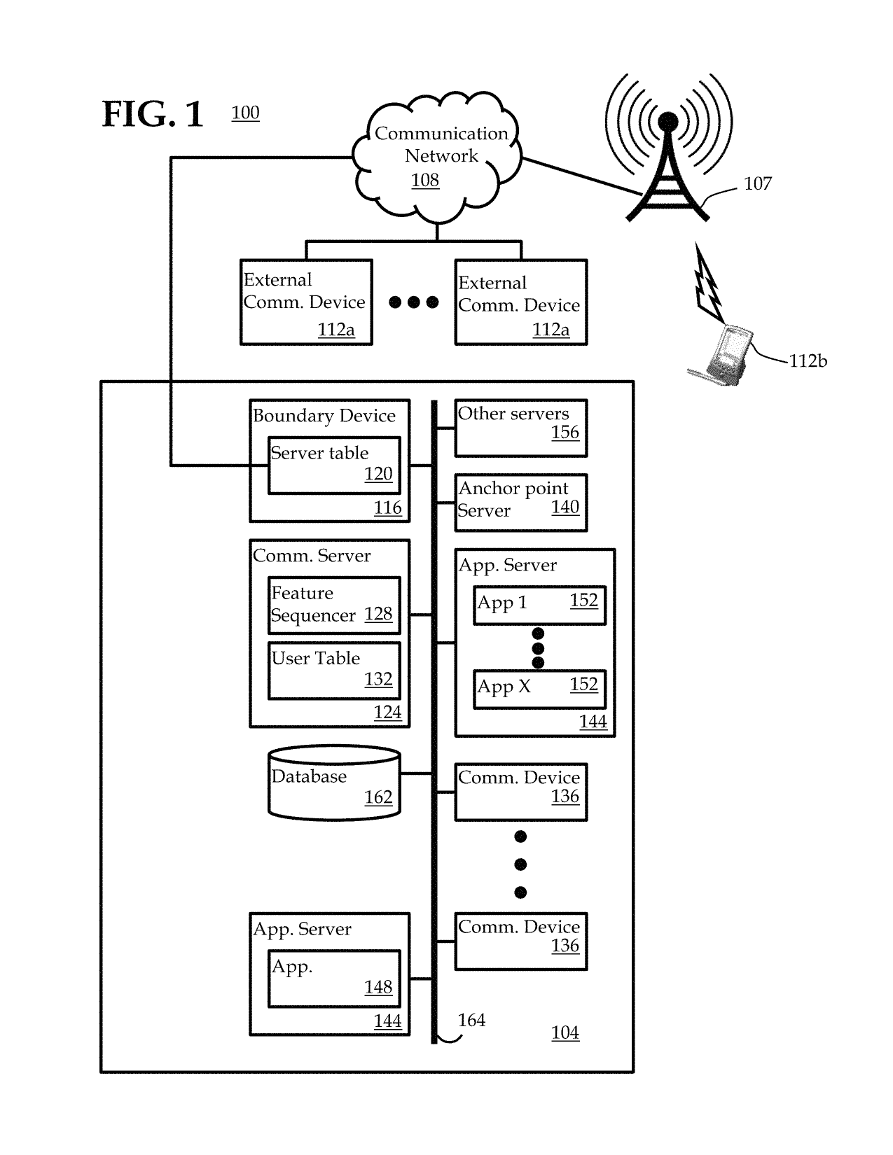

FIG. 1 depicts a communication system 100 according to an embodiment of the present disclosure. The communication system 100 may include an enterprise network 104 that is in communication, via a (typically untrusted or unsecure or public) communication network 108, with one or more external wired or wireless communication devices 112a and/or 112b (collectively, external communication devices 112). The external communication devices 112 are generally referred to as “external” because they are either not under the direct control of the enterprise administering the enterprise network 104 or have a decreased level of trust with the enterprise network 104 as compared with communication devices 136 that are within the enterprise network 104. Exemplary types of external communication devices 112 include, without limitation, stationary or mobile devices including but not limited to cellular phones, smart phones, laptops, Personal Computers (PCs), personal digital assistants (PDAs), digital phones, analog phones, mobile digital tablets, and the like. Mobile devices 112b may be in wireless communication with a radio frequency (RF) base station 107 (e.g., a Wi-Fi access point, cell phone tower, etc.), which in turn is coupled to communication network 108.

The communication network 108 may be packet-switched and/or circuit-switched. An exemplary communication network 108 includes, without limitation, a Wide Area Network (WAN), such as the Internet, a Public Switched Telephone Network (PSTN), a Plain Old Telephone Service (POTS) network, a cellular communications network, or combinations thereof. In one configuration, the communication network 108 is a public network supporting the TCP/IP suite of protocols.

The enterprise network 104 may include a boundary device 116 including a server table 120, a communication server 124 including a coupon template sequencer 128 and a process engine 132, one or more internal communication devices 136, an anchor point server 140, one or more application servers 144, which may be capable of providing one application 148, or a set of different applications 152, a number of other servers 156, and a coupon template database 162, all of which are interconnected by a (trusted or secure or private) Local Area Network (LAN) 164. Some or all of the functions depicted in FIG. 1 may be co-hosted and/or co-resident on a single server or may be a network of servers located at the site or in multiple locations. The depiction of components in FIG. 1 is generally intended to be a logical depiction of the components of the system 100.

The LAN 164 can be secured from intrusion by untrusted parties by a gateway and/or firewall located between the LAN 164 and communication network 108. In some embodiments, the boundary device 116 may include the functionality of the gateway and/or firewall. In some embodiments, a separate gateway or firewall may be provided between the boundary device 116 and the communication network 108.

The communications server 124 can include a Private Branch eXchange (PBX), an enterprise switch, an enterprise server, combinations thereof, or other type of telecommunications system switch or server. The communication server 124 is preferably configured to execute telecommunication functions between users and marketing administrators or users among themselves on one or more social networks via the Internet or other communication network(s). Embodiments herein may refer to communication server 124 generically as a “session manager” for ease of reference.

Although only a single communications server 124 is depicted in FIG. 1, two or more communications servers 124 may be provided in a single enterprise network 104 or across multiple separate LANs 164 owned and operated by a single enterprise, or multiple enterprises, but separated by a communication network 108. In configurations where an enterprise or an enterprise network 104 includes two or more communications servers 124, each server 124 may comprise similar functionality, but may be provisioned for providing its features to only a subset of all enterprise users. In particular, a first communications server 124 may be authoritative for and services a first subset of enterprise users whereas a second communications server 124 may be authoritative for and services a second subset of enterprise users, where the first and second subsets of users generally do not share a common user. This is one reason why the network boundary device 116 may be provided with a server table 120.

Additionally, multiple servers 124 can support a common user community. For example, in geo-redundant configurations and other applications where users are not necessarily bound to a single application server, there may be a cluster of equivalent servers where a user can be serviced by any server in the cluster.

In accordance with at least some embodiments of the present invention, the mapping of user identities within a communication request does not necessarily have to occur at the network boundary device 116. For instance, the mapping between an authoritative server and a user may occur “behind” the network boundary device 116 within the enterprise network 104, WAN or the Internet.

In some embodiments, network boundary device 116 is responsible for initially routing communications within the enterprise network 104 to the communications server 124 responsible for servicing a particular user involved in the communication. For example, if a first enterprise user is being sent geo-location information, or object information or branded product/service information, by an external communication device 112, then the network boundary device 116 may initially receive the inbound request to receive the geo-location information, or object information or branded product/service information, determine that the request is directed toward the first enterprise user, e.g., a marketing administrator, other user, etc., reference the server table 120 to identify the authoritative communications server 124 for the first enterprise user, and route the inbound request to the authoritative communications server 124.

Likewise, communications between internal enterprise users (e.g., internal communication devices 136) may first be serviced by the originating user's authoritative communications server 124 during the origination phase of communications set-up. After the origination phase is complete, the authoritative communications server 124 of the terminating (or called) user may be invoked to complete the termination phase of communications set-up. In some embodiments, the communications server 124 for the originating and terminating user may be the same, but it is not necessarily required that the server be the same.

In situations where more than two enterprise users are involved in a communication session, authoritative communications servers 124 for each of the involved users may be employed without departing from the scope of the present invention. For example, marketing administrators and/or other users may be located at the same server or at different servers. Additionally, the authoritative communications servers 124 for each user may be in the same enterprise network 104 or in different enterprise networks 104, which are owned separately or by a common enterprise but are separated by the communication network 108.

Each communications server 124 includes a coupon template sequencer 128 and a process engine 132. The process engine 132 for a communications server 124 is used to combine the chosen coupon template with the user's media data object file. In particular, the process engine 132 may be accessible by users and/or by marketing administrative personnel. The combined coupon template and media data object file for a particular user are synchronized by the coupon template sequencer 128 to tag the geo-location information, and/or the object information and/or the branded product/service information, from the user with the newly created digital postcard. The coupon template sequencer 128 can provide communication features directly into the communication session or the coupon template sequencer 128 can determine an application sequence, which will be invoked during tagging, synthesizing of the template to the media data object file, and used during the communication session. An application sequence may indicate or control how a media data object (e.g., photo, textual message, and so forth as described elsewhere herein), including active elements (e.g., Flash, Shockwave, Java, etc.), will be included with the coupon template to produce the digital postcard.

In accordance with at least some embodiments, the coupon template sequencer 128 can determine an application sequence and cause one or more applications 148, 152 to be sequenced into a communication session. In particular, the coupon template sequencer 128 is configured to analyze a particular user's geo-location, object identification, branded product/service information, and related coupon template choice or proposed coupon template from user, and invoke the necessary applications to fulfil such preferences. Once an application sequence is determined by the coupon template sequencer 128, the communications server 124 passes the established combined file, or digital postcard to a first application in the application sequence, thereby allowing the first application to determine the parameters of the digital postcard, insert itself into the control and/or media stream of the communication session, and thereby bind itself to the communication session to allow the newly combined digital postcard to be sent to the user for posting on one or more social networks. Alternatively, the digital postcard may be stored and accessible at a later time during an access composition request by the same user, a different mobile user or users, or other administrators or users on the communication network.

Once the first application has inserted itself into the communication session, the first application either passes the established digital postcard back to the coupon template sequencer 128 for marketing administrator approval or passes the established digital postcard directly to a second application in the application sequence. Alternatively, or in addition, the digital postcard may be redirected, rejected, or the like. Moreover, parties and/or media servers may be added to the session by an application. As can be appreciated, the process continues until all applications have been included in the communication session and the process can be duplicated for each of the users involved in the communication session.

Although only two application servers 144 are depicted, one skilled in the art will appreciate the one, two, three, or more applications servers 144 can be provided and each server may be configured to provide one or more applications. The applications provided by a particular application server 144 may vary depending upon the capabilities of the server 144 and in the event that a particular application server 144 comprises a set of applications 152, one, some, or all of the applications in that set of applications 152 may be included in a particular application sequence. There is no requirement, however, that all applications in a set of applications 152 be included in an application sequence and there is no requirement as to the order in which applications are included in the application sequence. Rather, the application sequence is usually determined based on a user's or administrator's coupon template preferences, which can be processed in the process engine 132. Alternatively, or in addition, the applications that appear in a user's sequence vector and their order within that vector may be determined by a system administrator to satisfy business requirements.

Moreover, the application sequence can vary based on the media type(s) that are being used in the communication session. For instance, a user may have a first set of preferences for photographic data communications, a second set of preferences for video-based communications, and a third set of preferences for text-based or audio-based communications. Additionally, a user may have preferences defining preferred media types and rules for converting communication sessions from one media type to another different media type. Still further, a user may have preferences defining the manner in which multi-media communications are established and conducted.

The applications included in a particular application sequence are generally included to accommodate the user's preferences. Applications may vary according to media-type, function, and the like. Exemplary types of applications include, without limitation, an EC-500 (extension to cellular) application, an email application, a video application, a text application, a geo-location log service, a security application, an encryption application, a collaboration application, a whiteboard application, mobility applications, presence applications, media applications, messaging applications, bridging applications, bar code or QR code applications, object identification applications, digital coupon template applications, product/service brand applications, and any other type of application that can supplement or enhance communications. Additionally, one, two, three, or more applications of a given type can be included in a single application sequence without departing from the scope of the present invention.

Embodiments of the present invention are largely comprised of a set of different software entities working in harmony on an existing architecture (e.g., the web) and integrating with other established or non-established social networking and location-based applications (or object or brand-based, or experience-based applications). Software may also be responsible for synthesizing the existing and new personalized digital data to create a new media data object file for distribution locally or within and throughout a social network or social networks.

Embodiments of the present invention may utilize the communication system of FIG. 1 to allow users to generate their own media coupon template data for free market distribution and financial gain through a separate interface. A marketing administrator or designer at one of external communication devices 112 may utilize the system of FIG. 1 to create a “digital postcard coupon template” to be stored in database 162, and that users/consumers can search for and combine with their own media data object file captured at a particular location, with a particular object (e.g., person or thing) or with a branded product/service. When that consumer uploads the digital postcard to his or her social media network(s), the information from the user may be synthesized with centrally accessed information about the business location, object, or product/service being endorsed and socially proven by the user who created the media data object file.

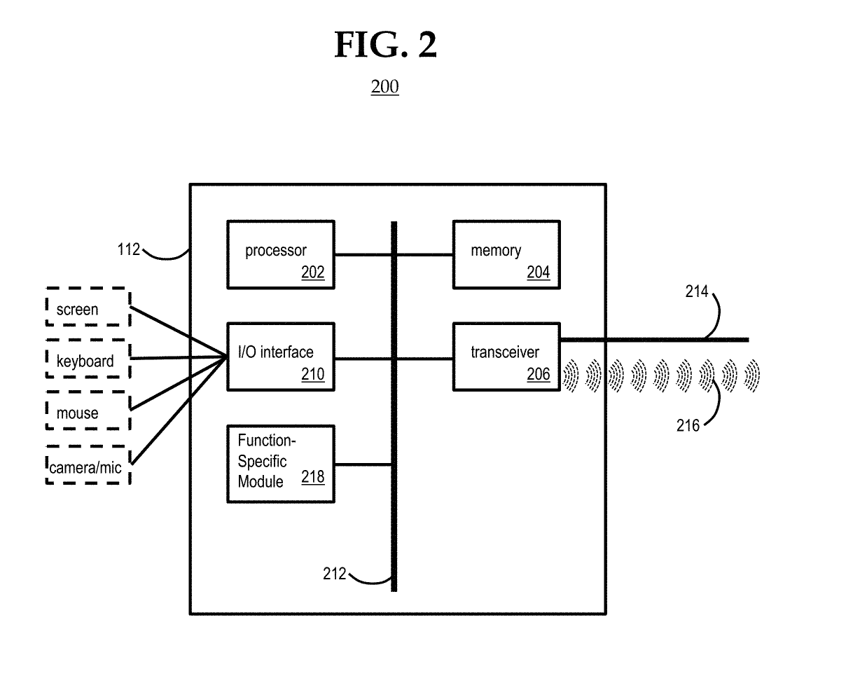

FIG. 2 illustrates an architecture for an external communication device 112. External communication device 112 may include a processor 202, a memory 204 coupled to the processor, a receiver and/or transmitter (collectively, transceiver 206), one or more function-specific modules 218, and/or I/O interfaces 210. Separate function-specific modules 218 may be provided for different functions provided by external communication device 112. Transceiver 206 couples external communication device 112 to an internal and/or external communication path such as an Ethernet connection 214 and/or an optional RF connection 216. RF connection 216 may be WiFi, Bluetooth, ZigBee, UWB, or similar technologies used for RF networking, or 3G/4G/4G-LTE/5G, etc. for cellular communication. I/O interfaces 210 couple agenda server 102 to one or more optional user input/output (I/O) devices (e.g., display screen, keyboard, mouse, etc.). Memory 204 stores data and/or program instructions used by processor 202. Memory 204 may include permanent, non-volatile memory (e.g., ROM), or volatile memory (e.g., RAM), or rewritable memory (e.g., hard drive or flash memory), or any combination thereof. One or more function-specific modules 218 may be used to help carry out processes of the embodiments described herein. Components of external communication device 112 may be interconnected by communication path 212. The program instructions, when executed by processor 202, carry out the processes performed by external communication device 112.

Enabling a sharable benefit by the business may include providing a coupon template that defines the business-related boundaries of a benefit offered by the business, e.g., an allowable percentage discount, what items the discount applies to, expiration or blackout dates, amount of rebate or loyalty points, and so forth. The benefit is a benefit that would be relevant to a customer, and in particular to a targeted customer who would use the coupon. For example, a benefit may include a rebate or other monetary benefit, gratuity, thank-you gift or other non-monetary benefit, benefits in an affiliated account (e.g., double points on a credit card or loyalty card), etc., as determined by the business. As a counter-example, an interest rate offer is not likely to be relevant to a restaurant-based business or to the targeted customer of a restaurant. The coupon template, before customization by a user, does not necessarily define a layout of how the business-related boundaries of the benefit will be graphical presented to a user or recipient. The coupon template may be customized to a geographic location or other characteristic (e.g., a demographic) of the requesting user when a coupon template is selected by the requesting user. The coupon template may then be customized by a user (e.g., by adding or modifying a user-supplied photo, adding or modifying a stock system-supplied photo, adding or modifying a user-supplied message to the intended recipient, adding or modifying a user-supplied audio signal, adding or modifying an artistic graphic element (e.g., free-form finger drawing, hearts, smiley face, emoticon, etc.) and so forth) to generate a Photopon location-based coupon, and sending the Photopon location-based coupon to an intended recipient. An audio signal may include a voice recording, music, tones, ringtones, beeps, etc. Such customization may allow a user to create a coupon that is more realistic (e.g., uses real photos rather than a doctored composite photo such as one person's head on a different person's body), and is likely to lead to a higher response rate from a recipient. A more realistic photo is more likely to focus a recipient user's attention on the business offer rather than on flaws in the photo.

When a requesting user selects a coupon template and shares a location-based coupon, embodiments may generate a unique coupon code based on one or more of a selected coupon ID, a coupon template ID, and/or a user ID for visual promotion and tracking in a coupon template-based system.

In order to improve content quality and relevance in the same coupon template based system, e.g., by ensuring that the requesting user snaps a photo of something relevant to the actual selected coupon template, the requesting user has an option to save more on a product or service that they may buy or consume now if they convert the photo into a location-based coupon. Such a requesting user may save even more if a friend redeems a location-based coupon, because the requesting user will receive a rebate or other monetary benefit, gratuity, thank-you gift or other non-monetary benefit, benefits in an affiliated account (e.g., double points on a credit card), etc., as determined by the business. The options offered to the requesting user may be manageable by the business inside the same coupon template based system.

In some embodiments, a requesting user may earn a base predetermined reward level or other benefit simply from creating a custom relevant location-based coupon as a gift to a recipient user, even if the recipient user does not redeem the location-based coupon. The base predetermined reward level rewards the requesting user for the effort of creating a relevant photo, review and/or explanation of the good or service that the requesting user is enjoying in person. A recipient user may treat the location-based coupon with a relatively higher level of trust compared to mass marketing because the location-based coupon may be interpreted as a form of social proof—the location-based coupon is a first-hand testimonial description from a trusted person together with a visual artifact (i.e., a photo) to accompany it. Such interpretations make a recipient user to be far more likely to redeem the location-based coupon, and thereby convert the recipient user to a future longtime customer. In contrast to conventional mass marketing in which businesses may try to collect personal information impersonally in order to find receptive consumers, embodiments in accordance with the present disclosure allow personal information to stay private while still targeting offers to receptive consumers.

Furthermore, because friends and other recipient users in general are not as likely to redeem content with poor quality photography, this provides a stronger financial incentive for the location-based coupon author using the coupon template to produce higher-quality content. This also provides incentive for the requesting user to follow-up with other recipient users to redeem their location-based coupons.

In some embodiments, each time a requesting user shares a location-based coupon, the corresponding coupon template is updated with the additional photos and unique IDs of other users who have also shared the same coupon template as their own personalized location-based coupon. Coupons may be personalized for design content (e.g., photograph, written message, layout, etc.) within any boundaries set by the retailer regarding business-related boundaries of the offer (e.g., percentage discount, items included in or excluded from the offer, blackout days, etc.). Personalized coupons are more likely to be noticed by a recipient and redeemed. This helps provide deep customer intent and loyalty tracking. Deep customer impact in this context means at least a clearer, deeper and/or more insightful picture or analysis of customer intent, i.e., what the customer may be looking to purchase versus what is available to the customer or what the customer actually settles for purchase if what they are looking for is not available.

To help prevent abuse, this new location-based coupon redemption code can only be accessed on-site or in close proximity to the location hosting the original coupon templates within the coupon template system.

Furthermore, a clout score is generated for businesses to target their coupon templates based on influential power. Clout is associated with a requesting user who desires to send a location-based coupon. Clout may be determined by a number of ways, such as a number of requests for location-based coupons, a number of location-based coupons that were forwarded, a number of forwarded location-based coupons that were redeemed, a percentage of forwarded location-based coupons that were redeemed, and/or any combination of such metrics, and so forth. Clout may also be determined by recent trends in such metrics. For example, a requesting user who in the past had not requested many location-based coupons, but recently has requested many location-based coupons and has had them redeemed, may have a relatively higher clout than another requesting user with similar absolute number but who has been inactive recently.

A requesting user may have varying degrees of clout with respect to individual businesses or an industry. For example, a frequent patron of a first business may have high clout with the first business but less clout with a second business, unless the second business is trying to gain market share from the first business. Conversely, a requesting user such as a published food critic may have high clout across multiple businesses within an entire industry.

When a recipient user redeems a requesting user's location-based coupon, certain benefits may accrue to the requesting user. For example, the requesting user may receive rewards, loyalty points, commission, future discounts, and so forth, any of which may involve participation by participating vendors or suppliers, etc.

A requesting user's clout increases as more recipient users redeem a requesting user's location-based coupons. A business associated with the location-based coupon may offer more incentives to a requesting user with more clout. A second vendor of related goods or services may be able to offer incentives to requesting users with high clout. In some embodiments, the second vendor may be a non-competitor of the business. Management of clout-based incentives may be automatic or via automated processes. In some embodiments, the business may inform the requesting user as to what visual coupon templates are available for sending by the requesting user.

In some embodiments, location-based coupons in accordance with an embodiment of the present embodiments may bear an expiration date that is independent of an expiration date of an associated coupon template. For example, the expiration date of the location-based coupon may be before, after, or coterminous with the coupon template expiration date. Some embodiments may include a social expiration date for the location-based coupons generated from a coupon template.

As used herein, a social expiration date may refer to an expiration date that the author of the location-based coupons creates in order to help entice their friends to meet them. For example, a business may create a coupon template with an expiration date 30 days from now. A requesting user may utilize the coupon template to create a location-based coupon that has a different expiration date to control when the recipient user is able to redeem the location-based coupon. For example, a requesting user may set an expiration date for a location-based coupon to be tonight at midnight, even though the business may treat it as valid for up to 30 days, because the requesting user wants to meet the recipient user tonight before midnight.

Since a requesting user can create their own new coupon and unique coupon code from an original coupon, they can also specify their own unique expiration date to make things more interesting, enjoyable and fun because of the real-time aspect of embodiments of the coupon template-based system described herein. This is important because it taps into human psychology in order to create a sense of urgency, and to instill in the recipient user a fear of missing out.

Setting a time limit on usage of the location-based coupon taps into the science behind promotions. The time limit may be set by the business or by the requesting user. By placing a time limit on the location-based coupon, a recipient user is more likely to reply and use the location-based coupon (e.g., by meeting their friends at the issuing business). A perception of real-time opportunity can be created with some short-term time limits, e.g., a deadline measured as mere hours in the future may encourage a recipient user to use the location-based coupon, and to use it quickly.

In some embodiments, requesting users with a high clout score may also be allowed by a business to extend the actual expiration date. The amount of time extension may be determined by the requesting user or by the business. In some embodiments, the business may set a maximum amount of time (e.g., no more than one extra week) or a maximum time limit (e.g., not past the end of the month) or a predetermined range of time (e.g., next four Mondays for a Monday night football event). Other types of extensions may also be used.

Some embodiments may provide private chat sessions to offer advice such as tips on how to redeem, who to go to for the offer, what time is best to visit the location hosting the promotion, and so forth. A private chat session may take place between the location-based coupon creator and the recipient user to help the recipient user redeem the location-based coupon. The requesting user has an incentive to help the recipient user use the location-based coupon, since the requesting user receives incentives or other benefits when the recipient user redeems the location-based coupon.

In contrast to an instant message session, a private chat session channels everything through a location-based coupon template. In this case, an “active coupon template” is used because, by selecting the active coupon template, a requesting user can access real-time feedback being exchanged about the promotional offer from substantially every location-based coupon that was generated with that active coupon template.

For example, when a requesting user creates a location-based coupon using coupon template “A”, a recipient user may check in to that location-based coupon in order to learn more about this offer's status, term, usage, etc. from other recipient users. Others who have also used the location-based coupon template to create their own location-based coupon may respond and communicate in real-time with the recipient user. In contrast to the known art, this process is entirely unique because it makes the social aspect of local offers to be a key differentiating aspect.

Embodiments thus address reluctance of users of other reviewing or ranking sites to leave their own feedback. Embodiments make it very difficult to post bogus reviews because access for contributing reviews is limited to individual social circles who are communicating directly with on another around a common relevant location-based coupon template.

Embodiments in accordance with the present disclosure provide a unique, highly effective, efficient, fun, and/or high-quality system for promotions and promotion amplification system. The system may be highly responsive and allow requesting users and recipient users to interact in a near-real-time environment.

Embodiments in accordance with the present disclosure also include a process that may be implemented on a mobile computing device that includes a display screen, and in particular a graphical display screen. Embodiments may further include a visual code reader to read a code such as a QR codes, and may include a display capability to display a code such as a QR code or other information commonly found on a business card. Embodiments are able to produce and display on the screen of the mobile device, upon a signal from a requesting user, a QR code that is able to convey at least as much information as a traditional business card (e.g., name, address, phone, email, title, and/or affiliation, etc.), thereby reducing or eliminating a need to carry traditional business cards. Alternatively, the requesting user may carry cards that can now be used to convey alternative information (e.g., photographs, graphic art samples) since the card does not need to include information already conveyed by the QR code.

QR-enabled embodiments enable recipient users to scan a code to exchanging information found on business cards, and optionally to electronically follow the other person. “Follow” is used in the sense that a first user may be added to a second user's list of contacts if the first and second users are in a same social network. If the first and second users are outside a social network, the first user may be added directly into a private contacts list on a smartphone that is not shared over a network. In contrast, the conventional art lacks the same level of separation safeguards. Embodiments allow a first user to set what profile information that a second user using a QR-enabled embodiment is allowed to receive and follow (e.g., sent or received location-based coupons, posts on predetermined social media sites such as LinkedIn™, Twitter™, etc. If the second user also has installed a QR-enabled embodiment, the second user may automatically follow the first user on the predetermined social media site. QR-enabled embodiments reduce or eliminate a need for a traditional business card.

Embodiments may maintain a set of QR contact information received and extracted from received display code. The set of QR contact information may include a plurality of records, one record per contact. Each record may include a plurality of fields, such as name, address, phone, email, title, and/or affiliation, etc. In some embodiments, the QR contact information may be maintained separately from contact information from other sources such as an instant-message buddies list or email contact list, in order to facilitate usage of the QR contact information for separate purposes. Separate purposes may include exchanging location-based coupons. Embodiments may automatically associates an event name, event date, and/or photos taken at the event with a new record of QR contact information. Such associations may be beneficial to help users to remember the context or circumstances (e.g., when, where, what event, etc.) that resulted in a record of QR contact information being recorded as one of a user's contacts.

Some embodiments provide an ability to generate and scan alphanumeric codes or visually unique codes (e.g., QR codes) to automatically find and redeem location-based coupons at a physical location as well as groups (e.g., social circles) from the same location.

For example, if a recipient user receives a location-based coupon from a friend, the recipient user may display a redemption QR code or other code generated by embodiments at the time of creation of the location-based coupon in order to redeem the location-based coupon as a group. An advantage is that there may be certain discount requirements (e.g., a minimum group size) in order to encourage a positive group first impression or experience of the business. The positive group experience will tend to makes it much more likely that such a recipient user will convert to a long-term customer for less cost and hassle than the known art. Embodiments provide a deep psychological subconscious relationship between the business and the recipient user's overall impression and feelings towards that business.

In one usage example in accordance with an embodiment of the present disclosure, a customer may visit a business location and an initial QR code or the like is presented to the customer. For example, a QR code may be printed on a menu, a table tent card, a napkin, and so forth. The customer may scan the QR card to check-in. Upon check-in, the QR-embodiment would know the location ID, and then retrieve and present to the requesting user a set of coupon templates for use in generating a new location-based coupon. After the new location-based coupon is generated, the recipient user can redeem it by scanning the same QR code to prove that they are in fact at the business.

At that point a redeem code may be presented to the customer. The redeem code is a unique new coupon code the business and customer can now track after it is created, in order to use as a separate promotion and/or a referral code to another potential customer.

Redeem codes, combined with a requirement that the physical geographical location be within a predetermined distance limit, helps prevent system abuse and helps the business owner keep track of promotion creation and/or regeneration (i.e., the location-based coupons created by requesting users), usage (tracked via location-based coupons creation) and redemption accuracy. Furthermore for redemption, to prevent system abuse, checkpoints for location-based coupon codes also may be generated by a combination of unique device ID of the user and user ID, in addition to an anchoring coupon template ID. Embodiments are free to provide additional checkpoints.

In another example of usage in accordance with an embodiment of the present disclosure, a requesting user can view the availability of coupon templates offered by businesses that are geographically near to the requesting user, but the requesting user cannot use a coupon template until they travel to site or otherwise visit the physical site of the participating merchant in person, and scan the QR code on the menu or poster or some other medium on-site.

In such an exemplary usage, a new QR code is generated that only friends of the requesting user can redeem by traveling to that business or another specified business in the coupon template system (e.g., another restaurant owned by the same business owner). Since the business may have already specified the locations that the coupon template or coupon templates are available at and can be redeemed at, it helps prevent abuse by requiring that recipients of the location-based coupons are able to redeem them only at locations specified in the coupon template. Geographic locations may be determined through GPS coordinates of the mobile device. GPS is known as an RF-based technology. The user who requested, created and sent the location-based coupon does not need to scan anything further since the requesting user in general might not accompany the recipient to provide the recipient a new QR code.

Geographic location information (also known as geo-location information), such as geographic location information about a user or about a recipient of a Photopon location-based coupon, may be determined by use of RF-based location determination technology other than GPS. For example, a short-range location service or location determination system may augment GPS data or may be used when GPS data is not available or not preferred (e.g., at indoor locations with poor or unusable GPS signal strength). An example of a short-range location determination system is iBeacon™ technology. iBeacon refers to an indoor proximity system that uses low-powered, low-cost transmitters that can notify nearby communication devices (e.g., external communication device 112 such as Apple™ iOS 7 devices) of their presence. The technology uses Bluetooth low energy proximity sensing to transmit from a relatively fixed base location a universally unique identifier that is received by a relatively mobile compatible app or operating system. The identifier can then be looked-up over the Internet to determine the device's physical location or trigger an action on the device, such as an interaction with embodiments in accordance with the present disclosure. The technology enables a smart phone or other device to perform actions when in close proximity to a compatible transponder. For example, enabled smart phones may determine a more precise position or context in which to perform other actions. With such a short-range location system, a smartphone can pinpoint its own location in a store or shopping area, in order to further customize coupon templates for users (e.g., to distinguish a grocery store from a donut counter or coffee kiosk within the grocery store).

In another example of usage in accordance with an embodiment of the present disclosure, the requesting user may meet the recipient user and be able to provide a new custom redeem code for scanning by the recipient user. In such an exemplary usage, the friends may be meeting and collectively redeeming an offer. Such usage is likely to give the recipient user a favorable first impression of the business because the context is that the recipient user is experiencing the business together with friends, so the recipient user is more likely to come back and convert to repeat customers. In this way, a psychological benefit or other intangible benefit is associated with the business, unlike other discount systems of the known art that operate only by providing financial benefits without providing intangible benefits.

In order to encourage an opportunity for intangible benefits by requesting users, a business may opt to provide extra discounts for real-time group redemption. A business at which group redemption takes place may be known as a “redeem scene.” Other requesting users that wish to join the social action and receive discounts at the current friend's “redeem scene” may do so via the aforementioned private chat option. As more people join, a greater discount may apply, according to rules and caps established by the business.

Benefits of embodiments include that the business is more likely to add last-minute customers to fill seats, while at the same time creating long-term repeat customers because they are having the most fun. This provides a very powerful, deeply integrated social proof mechanism as an intangible benefit to the customer.

Employees of the business may have access to a compatible scanner in order to mark a location-based coupon as having been used, and to automatically update a requesting user's reward balance, clout status or the like, and update a status of the promotion provided to the business. Real-time notifications may be sent to inform the business and/or requesting user.

In another example of usage in accordance with an embodiment of the present disclosure, a requesting user may enable their location-based coupon compatible mobile device to see what offers and/or offer coupon templates are offered by participating merchants close to the requesting user's present geographic location. The requesting user can select a participating merchant and redeem the offer themselves or can share the offer with a recipient user as a location-based coupon, if allowed by redemption rules specified by the participating merchant. Different levels of rewards may be available depending upon a mode of redemption, e.g., greater reward may accrue to the requesting user if the requesting user forwards the offer as a location-based coupon rather than the requesting user personally using the offer immediately.

Embodiments improve the relevancy of the offer to the requesting user, and the relevancy of the recipient (i.e., redeeming) users to the business. Location-based coupons sent by a requesting user represent an actual item that is relevant to the requesting user and/or recipient user, and may represent an implicit endorsement or recommendation by the requesting user, unlike a photo of a random object.

In some circumstances, customized coupons should be validated before being shared. For example, pictures taken by requesting users to use as part of a location-based coupon may lack a predetermined level of quality. For example, the picture may be blurry, too light, too dark, may not feature the product prominently enough, may be cut off along an edge of the photo, may have an unacceptable background (e.g., photobombing), may depict the product unflatteringly, and so forth. Customized coupons may also be validated with respect to any changes in business-related terms, such that the changes in terms are acceptable to the participating merchant. In order to deal with poor quality photographs, a business may set up and implement incremental incentives for customers in a coupon template management and rewards system, e.g., a tool to manage coupon templates in order to provide a system and method for sharing an experience. Embodiments described herein may facilitate establishing and/or using such a reward system in order to allow businesses to create incentives that encourage the location-based coupon consumer creating the location-based coupon to want to get more friends to redeem their location-based coupon. Incentives may include reward payments, e.g., rewards per redemption of a newly created, unique location-based coupon created with a personal photo of an offer item and an existing offer for that item, on a per-recipient basis.

Embodiments including an incentive as described herein will tend to encourage requesting users to create higher-quality photographs for use in a location-based coupon, because high-quality location-based coupons will tend to cause a recipient user to take greater notice and tend to produce a higher redemption rate. The incentive to requesting users to create a higher-quality location-based coupon may persist well after the requesting user has personally partaken in the good or service, because the opportunity to earn a reward from redemptions by a recipient user may last a long time. The overall content of a system embodiment will correspondingly increase, and tend to attract more requesting and/or participating users. Peer comparisons with other available location-based coupons may encourage requesting users to increase the quality of their own location-based coupons.

In some embodiments, a business user can track the secondary (and tertiary, etc.) coupon redemptions in order to gauge customer loyalty and clout score, etc., to as many degrees as specified by the business user.

As used herein “degrees” may refer to the number of relationships that exist between entities. For example, if a requesting user requests a location-based coupon and shares it with a first recipient user, and if the first recipient user further shares it with a second recipient user (who otherwise may be unknown to or unconnected to the requesting user), then it may be said that the second recipient user and the requesting user are separated by one degree. A similar idea may be known colloquially in other contexts as “Degrees of Bacon.” “Degree” is used by embodiments as a weight to help determine a user clout score and thereby help derive a requesting user's influential value to businesses providing location-based coupon templates and tracking rewards and loyalty rewards for that requesting user.

Degrees may become important when a requesting user creates a location-based coupon and sends it to a recipient user who further forwards the location-based coupon to a large number (e.g., more than ten) other recipient users to redeem the location-based coupon. This scenario may be problematic because there is no direct connection between the requesting user and the forwarded-to recipient users. Embodiments are able to track and allocate rewards to the requesting user and/or intermediate recipient users based upon redemptions by the forwarded-to recipient users. However, a reduced amount of clout may accrue to the requesting user because not all of the credit for the forwarded-to recipient users may be fairly attributed to the recipient user—at least some of the credit may be attributed to the intermediate recipient users. The amount of reduction may depend upon the degree of separation.

In some embodiments, a location-based coupon may be saved as a “snip” by a recipient user who may be interested in the location-based coupon at a later time. The snip allows such a recipient user to easily find the location-based coupon and redeem it when it is more convenient for the recipient user, e.g., when they are in the area or near a participating location or do not already have other plans or to wait in order to satisfy conditions pre-specified by the business user (e.g., not valid on weekends).

In some embodiments, a business user can track the secondary (and tertiary, and so on to the n-th degree, etc.) coupon redemptions and/or snips arising from location-based coupons derived from a requesting user (e.g., user “A”). Tracking may include friends of user “A”, the friends being designated as “group A.” Friends of the members of group “A” may be referred to as “group B,” and groups of associations may repeat this way to define “group C” and beyond.

In one tracking scenario, a recipient user “B” may redeem a location-based coupon from user “A” and then share the location-based coupon with their own friends (i.e., members of group “C”). Ordinarily, user “B” would not receive an incentive for resending since user “B” was not the original creator of the location-based coupon, unless user “B” added additional review comment (e.g., photo and review, or custom personal data) in order to make a new location-based coupon (e.g., a secondary location-based coupon). The secondary location-based coupon may include information from the parent location-based coupon, e.g., review content from user “A” as part of the location-based coupon created by user “B”. In this way, depending on implementation preferences, embodiments may accumulate personal content among location-based coupon authors, starting from an originating user “A”. Content may be repeated and successively built upon by multiple generations of location-based coupons or snips. In some embodiments, usage may be tracked among the generations of location-based coupons for business intelligence and to allow the business user to provide coupon templates and rewards.

In some embodiments, a requesting user's clout score may be tracked per customer of the business who is using the invention, while the customer is patronizing the business. Clout may also be tracked across generations of location-based coupons. In some embodiments, a customer with a high clout score (e.g., at least 90% of the location-based coupons that the customer sends to friends are in fact redeemed) is more valuable to the business, and may have a higher lifetime value at least as measured by an ability to produce profits for the business. Such customers may be rewarded by receiving better incentives. Some embodiments may attempt to model the lifetime value of the customer according to models that may be supplied by the business. Incentives to customers may be specified in advance either by an algorithm or directly by the business user during coupon template and rewards administration, or by a combination of such methods.

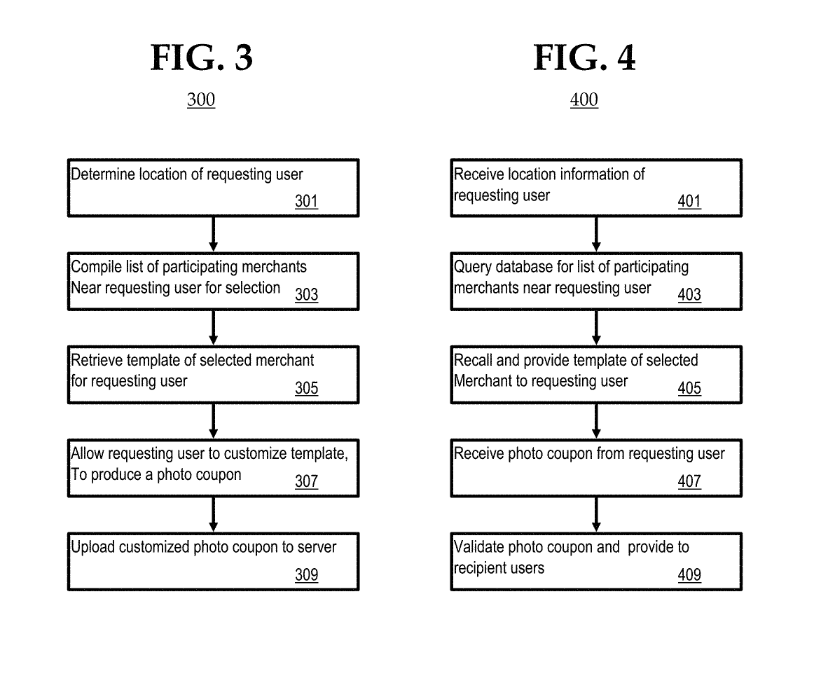

FIG. 3 illustrates at a high level of abstraction a process 300 in accordance with an embodiment of the present disclosure. Process 300 is illustrated from the perspective of an external communication device 112, including the user of external communication device 112. Process 300 begins at step 301, at which indicia of a location of a requesting user is determined. For example, the location may be determined by use of GPS methods and/or an indoor proximity system (e.g., iBeacon or the like), using signals received through transceiver 206. Location determination may be assisted with a function-specific module 218, e.g., a module that is capable of processing GPS and/or signals from an indoor proximity system. User location may be transmitted to an application server 144 in enterprise network 104 for further processing.

Next, process 300 transitions to step 303, at which a query result list of participating merchants near the requesting user is compiled. A threshold of nearness for purpose of compilation may be user-controlled (e.g., 10 yards, 1 mile, 5 miles, etc.) or system-controlled. A system-controlled threshold of nearness may be useful for push-type notifications. Threshold of nearness may depend upon a shopping or retail environment that the user is within. For example, a 10-yard threshold (rather than a 1-mile threshold) may be appropriate for distinguishing between multiple kiosks in a grocery store, bookstore, etc., but for such purposes a position determination or threshold of less than 1-foot is not likely to be necessary. Compilation may be performed by external communication device 112 from a list of nearby participating merchants returned by application server 144. Alternatively, compilation may be performed by application server 144 using the requesting user's location data as transmitted by external communication device 112, and the results of the compilation presented to the requesting user at external communication device 112. Compiling may include selecting an arrangement and presentation of the query result list, e.g., to emphasize certain participating merchants who may be part of a special promotion or who may be known to be popular (e.g., from reviews or crowd-sourcing), or may have been used in the past by the requesting user.

Next, process 300 transitions to step 305, at which coupon template data for the nearby participating merchants identified in step 303, which may be retrieved from a database such as database 162 of FIG. 1, is received from application server 144. Coupon template data or a portion thereof (such as a summary without the fine print) may be presented along with the compilation results in order to permit the requesting user to make a more informed choice when selecting a participating merchant.

Next, process 300 transitions to step 307, at which the requesting user may select a participating merchant and corresponding coupon template and then, under user control, customize the coupon template with the requesting user's personalized information (e.g., photos, messages, etc. as described earlier in this application) in order to produce a customized coupon.

Next, process 300 transitions to step 309, at which the customized coupon may be uploaded to application server 144 for validation. Validation may include making sure that the customized coupon is acceptable from a technical perspective (e.g., photos are not blurry, etc.), are acceptable from a content perspective (e.g., text is not profane, photos are relevant, photos are not sexting, etc.), and acceptable from a business offer perspective (e.g., if the requesting user has customized the offer, that the customized offer is within bounds that are acceptable to the participating merchant). If the customized coupon is acceptable to the participating merchant, it may then be distributed to recipients identified by the requesting user.

FIG. 4 illustrates at a high level of abstraction a process 400 in accordance with an embodiment of the present disclosure. Process 400 is illustrated from the perspective of a server such as application server 144. Process 400 begins at step 401, at which indicia of a location of a requesting user is received from the user. For example, the indicia of a location may be GPS coordinates and/or a location identifier derived from an indoor proximity system (e.g., iBeacon or the like).

Next, process 400 transitions to step 403, at which application server 144 may query database 162 to find participating merchants near the requesting user. A threshold of nearness for purpose of compilation may be user-controlled (e.g., 10 yards, 1 mile, 5 miles, etc.). Compilation of the nearby participating merchants may be performed by application server 144 using the requesting user's location data as transmitted by external communication device 112. Compiling may include selecting an arrangement and presentation of the query result list, e.g., to emphasize certain participating merchants who may be part of a special promotion or who may be known to be popular (e.g., from reviews or crowd-sourcing), or may have been used in the past by the requesting user.

Next, process 400 transitions to step 405, at which application server 144 retrieves coupon template data from memory (e.g., database 162) for the nearby participating merchants identified in step 403. Coupon template data or a portion thereof (such as a summary without the fine print) may be presented along with the compilation results in order to permit the requesting user to make a more informed choice when selecting a participating merchant.

Next, process 400 transitions to step 407, at which application server 144 receives from the requesting user a customized coupon template with the requesting user's personalized information (e.g., photos, messages, etc. as described earlier in this application) in order to produce a customized coupon.

Next, process 400 transitions to step 409, at which application server 144 validates the uploaded customized coupon. If the customized coupon is acceptable to the participating merchant, it may then be distributed to recipients identified by the requesting user. Application server 144 may additionally perform other functions related to the requesting or recipient users as described earlier, e.g., keeping track of loyalty points for the requesting user.

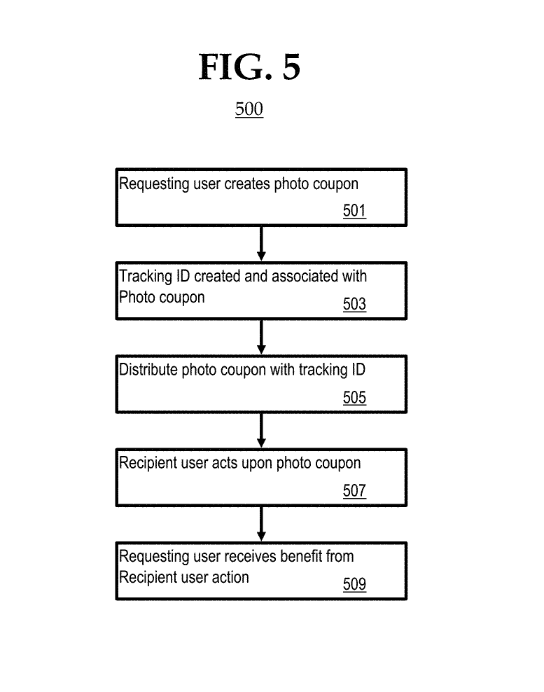

FIG. 5 illustrates at a high level of abstraction a process 500 in accordance with an embodiment of the present disclosure. FIG. 5 illustrates a method of providing a benefit to a requesting user depending upon actions taken by the recipient user. Process 500 begins at step 501, at which the requesting user creates a photo coupon as previously described.

Next, process 500 transitions to step 503, at which a tracking ID is created and associated with the photo coupon. The tracking ID includes information that associates the photo coupon with the requesting user. The tracking ID may be created when the requesting user creates the photo coupon. In other embodiments, if the photo coupon is uploaded to server-accessible storage, the tracking ID may be created and/or associated with the photo coupon at the server, such as application server 144.

Next, process 500 transitions to step 505, at which the photo coupon is distributed with the tracking ID. Distribution may take place from the requesting user directly to the recipient user (e.g., via email). In other embodiments, if the photo coupon is uploaded to server-accessible storage, the requesting user may instruct server 144 to distribute the photo coupon to a recipient user.

Next, process 500 transitions to step 507, at which the recipient user takes some relevant action based upon the photo coupon. Relevant actions may include viewing the photo coupon, clicking on the photo coupon for more information, adding an event described by the photo coupon to a calendar, redeeming the photo coupon, and so forth. Relevant actions may be defined by the requesting user or be predefined in server 144. When the recipient user performs a relevant action, a notification is communicated to server 144. The notification may include the tracking ID.

Next, process 500 transitions to step 509, at which server receives the notification that the recipient user performed a relevant action. Server 144 may associate the tracking ID in the notification with the requesting user, and thereupon provide a benefit to the requesting user. The benefit may be in a monetary form (e.g., a commission), non-monetary form (e.g., an increased clout score), or a form that may combine both monetary and non-monetary aspects (e.g., discount on a future purchase, free appetizer, etc.). The amount of benefit may depend upon the specific relevant action taken by the recipient user. A more valuable relevant action (e.g., making a purchase) may accrue greater benefit than a less valuable relevant action (e.g., viewing an offer). The requesting user may accrue multiple benefits if the recipient user performs multiple relevant actions. Greater benefits or more flexible benefits may accrue to requesting users with greater clout. Clout may “age”, such that older relevant actions provide less clout than more recent relevant actions of the same kind.

Embodiments of the present invention include a system having one or more processing units coupled to one or more memories. The one or more memories may be configured to store software that, when executed by the one or more processing unit, allows practice of the embodiments described herein, at least by use of processes described herein, including at least in FIGS. 3-5, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiments were chosen and described in order to best explain the principles of the present invention and its practical application, to thereby enable others skilled in the art to best utilize the present invention and various embodiments with various modifications as are suited to the particular use contemplated.

What has been described above includes examples of the disclosed architecture. It is, of course, not possible to describe every conceivable combination of components and/or methodologies, but one of ordinary skill in the art may recognize many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term comprising” as “comprising” is interpreted when employed as a transitional word in a claim.

What is claimed is:

1. A digital processing system to communicate and track a template-based customized digital object through social media, comprising:
a mobile user terminal, comprising:
a first radio-frequency (RF) interface to receive position location signals;
a processor coupled to a memory, the processor to determine a geographic location of the mobile user terminal from the position location signals;
a second RF interface to exchange signals with a wide-area network; and
a user interface to display a digital object template, and to accept user commands for editing the digital object template; and
a server, comprising:
a communication interface to the wide-area network, to receive a first signal indicating the geographic location of the mobile user terminal, and a second signal representing a media data object from the mobile user terminal;
a database to store a plurality of templates, at least one template comprising the digital object template displayed on the user interface of the mobile user terminal, wherein the digital object template is sent via the communication interface;
a processor coupled to a memory, the processor creating a customized digital object by combining the digital object template with the media data object according to user commands from the mobile user terminal; and
a presentation module to present through social media the customized digital object to a recipient user at another mobile user terminal.

2. The digital processing system of claim 1, wherein the digital object template displayed on the user interface of the mobile user terminal corresponds to a merchant within a configurable distance threshold of the geographic location of the user terminal.

3. The digital processing system of claim 1, wherein the digital object template displayed on the user interface of the mobile user terminal comprises an indicia of validity of the digital object template.

4. The digital processing system of claim 3, wherein the indicia of validity of the digital object template are modifiable by a user of the mobile terminal.

5. The digital processing system of claim 4, wherein limits to modification of the indicia of validity are determined by clout of the user of the mobile terminal.

6. The digital processing system of claim 1, wherein the position location signals comprise signals from a short-range location determination system.

7. The digital processing system of claim 1, wherein the position location signals comprise satellite-based signals.

8. The digital processing system of claim 1, wherein the media data object comprises a user-supplied photo.

9. The digital processing system of claim 1, wherein the media data object comprises a user-supplied textual message.

10. The digital processing system of claim 1, wherein the server further comprises a tracking module to track and allocate a benefit when the recipient user redeems the customized digital object.

11. The digital processing system of claim 10, wherein tracking module further tracks whether the mobile terminal user has been at a predetermined location.

12. The digital processing system of claim 1, wherein the digital object template is customized for a determined location of the mobile user terminal.

13. The digital processing system of claim 1, wherein the customized digital object comprises a code to identify the mobile user terminal.

14. A mobile user device to communicate and track a template-based customized digital object through social media, comprising:
a first radio-frequency (RF) interface to receive position location signals;
a processor coupled to a memory, the processor to determine a geographic location of the mobile user device from the position location signals;
a second RF interface to exchange signals with a wide-area network coupled to a server; and
a user interface to display a digital object template, and to accept user commands for editing the digital object template,
wherein the server comprises:
a communication interface to the wide-area network, to receive a first signal indicating the geographic location of the mobile user device, and a second signal representing a media data object from the mobile user device;
a database to store a plurality of templates, at least one template comprising the digital object template displayed on the user interface of the mobile user device, wherein the digital object template is sent via the communication interface;
a processor coupled to a memory, the processor creating a customized digital object by combining the digital object template with the media data object according to user commands from the mobile user device; and
a presentation module to present through social media the customized digital object to a recipient user at another mobile user device.

15. A server to communicate and track a template-based customized digital object through social media, comprising:
a communication interface to the wide-area network, to receive a first signal indicating the geographic location of a mobile user device, and a second signal representing a media data object from the mobile user device;
a database to store a plurality of templates, at least one template comprising the digital object template displayed on the user interface of the mobile user device, wherein the digital object template is sent via the communication interface;
a processor coupled to a memory, the processor creating a customized digital object by combining the digital object template with the media data object according to user commands from the mobile user device; and
a presentation module to present through social media the customized digital object to a recipient user at another mobile user device,
wherein the mobile user device comprises:
a first radio-frequency (RF) interface to receive position location signals;
a processor coupled to a memory, the processor to determine a geographic location of the mobile user device from the position location signals;
a second RF interface to exchange signals with a wide-area network coupled to a server; and
a user interface to display a digital object template, and to accept user commands for editing the digital object template.
